(19) United States
(12) Patent Application Publication
(10) Pub. No.: US 2015/0188932 A1
(43) Pub. Date: Jul. 2, 2015

(54) APPARATUS, SYSTEM, AND METHOD FOR IDENTIFYING A MAN-IN-THE-MIDDLE (MITM) CONNECTION

(71) Applicant: Samsung Electronics Co., Ltd., Suwon-si (KR)

(72) Inventors: Peter KING, San Mateo, CA (US); Abraham KANG, Los Gatos, CA (US)

(73) Assignee: Samsung Electronics Co., Ltd., Suwon-si (KR)

(21) Appl. No.: 14/145,155

(22) Filed: Dec. 31, 2013

(51) Int. Cl. H04L 29/06

(52) U.S. Cl. CPC H04L 63/1408

(57) ABSTRACT

An apparatus and method for identifying a Man-In-The-Middle (MITM) connection are provided. The method includes browsing a website using a terminal operatively connected to a network, determining a security level of the website according to characteristics of the website, determining whether the security level of the website is consistent with the stored information relating to the security of the website, and providing an indication that the network has an elevated likelihood of having an MITM if the security level of the website is inconsistent with the stored information relating to the security of the website.

### TECHNICAL FIELD

The present disclosure relates to an apparatus, system, and method for identifying a Man-In-The-Middle (MITM) connection. More particularly, the present disclosure relates to an apparatus, system, and method for identifying an MITM connection and alerting a user that a connection may be compromised.

### BACKGROUND

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

As mobile terminals are becoming more popular and integrated into daily life, the mobile terminals are used to access various networks in order to transmit and receive data and/or to consume content. However, users of the mobile terminals are oftentimes not aware of the security or safety of the network to which the mobile terminals are being connected. For example, a network to which the mobile terminal is connected may be compromised by another malicious party.

The malicious party may eavesdrop on the communications between the mobile terminal and the network (e.g., an access point). For example, the malicious party may form a Man-In-The-Middle (MITM) connection. The malicious party may use the MITM connection to intercept communications between two connections (e.g., a mobile terminal and an access point, or a connection between two mobile terminals).

As a result, when a malicious party establishes an MITM connection, the malicious party may engage in an MITM attack. An MITM attack occurs when an attacker (e.g., the malicious party) is able to deceive a victim (e.g., the mobile terminal) into routing communications (e.g., requests to the Internet) through the malicious party's terminal Once the MITM connection and attack is established, the malicious party has the ability to view all traffic sent from the mobile terminal (e.g., the victim) to the network (e.g., the Internet). Consequently, as an example, if the user of the mobile terminal logs into a banking website, the malicious party is able to retrieve the user's username (e.g., login Identifier (ID)), password, and financial data communicated between the user and the banking website, and/or the like.

As a result of the popularity of mobile terminals the popularity of using mobile terminals to access various networks the security of which may be unknown at the time of connection thereto, MITM attacks have become more popular. In addition, MITM attacks have been made easier with tools such as SSLStrip and SSLSnoop.

According to the related art, MITM attacks may be detected based on analyzing clock cycles, network hopes, autonomous system paths, and activity recording. However, such methods for detecting MITM attacks fail to take into account popular MITM tool techniques when detecting MITM attacks.

Accordingly, there is a need for an apparatus, system, and method for identifying or detecting MITM connections more effectively.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus, system, and method for identifying a Man-In-The-Middle (MITM) connection.

In accordance with an aspect of the present disclosure, a method for identifying an MITM connection is provided. The method includes browsing a website using a terminal operatively connected to a network, determining a security level of the website according to characteristics of the website, determining whether the security level of the website is consistent with the stored information relating to the security of the website, and providing an indication that the network has an elevated likelihood of having an MITM if the security level of the website is inconsistent with the stored information relating to the security of the website.

In accordance with another aspect of the present disclosure, an apparatus for identifying an MITM connection is provided is provided. The apparatus includes a communication unit configured to communicate with a network, and a control unit configured to browse a website, to determine a security level of the website according to characteristics of the website, to determine whether the security level of the website is consistent with the stored information relating to the security of the website, and to provide an indication that the network has an elevated likelihood of having an MITM if the security level of the website is inconsistent with the stored information relating to the security of the website.

In accordance with another aspect of the present disclosure, a method for identifying an MITM connection is provided is provided. The method includes browsing a website using a terminal operatively connected to a network, determining a security level of the website according to whether the website is provided as a secure website or an insecure website, determining whether a database stores information relating to a security of the website, if the database is determined to store information relating to the security of the website, determining whether the security level of the website is consistent with the stored information relating to the security of the website, and providing an indication that the network has an elevated likelihood of having an MITM if the security level of the website is inconsistent with the stored information relating to the security of the website.

In accordance with another aspect of the present disclosure, a system for identifying an MITM connection is provided is provided. The system includes an Access Point (AP) configured to provide access to a network, and a terminal configured to communicate with the network, to browse a website, to determine a security level of the website according to characteristics of the website, to determine whether the security level of the website is consistent with the stored information relating to the security of the website, and to provide an indication that the network has an elevated likelihood of having an MITM if the security level of the website if inconsistent with the stored information relating to the security of the website.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent According to various embodiments of the present disclosure, from the following description taken in conjunction with the accompanying drawings, in which:

FIG. 1 illustrates a system for identifying a Man-In-The-Middle (MITM) connection according to various embodiments of the present disclosure;

FIG. 2 is a flowchart illustrating a method of identifying an MITM connection according to various embodiment of the present disclosure;

FIG. 3 is a flowchart illustrating a method of identifying an MITM connection according to various embodiment of the present disclosure;

FIG. 4 is a block diagram of a terminal according to various embodiments of the present disclosure;

FIG. 5 is a block diagram of an Access Point (AP) according to various embodiments of the present disclosure; and

FIG. 6 is a block diagram of a server according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (“DVD”) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (“CT”) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

Various embodiments of the present disclosure include an apparatus, a system, and a method for identifying a Man-In-The-Middle connection.

According to various embodiments of the present disclosure, a terminal may record information relating to an indication and/or likelihood that a network has an MITM attacker thereon or that the network is otherwise unsecure or compromised. According to various embodiments of the present disclosure, the mobile terminal may store the information relating to an indication and/or likelihood that a network has an MITM attacker thereon locally. According to various embodiments of the present disclosure, the mobile terminal may transmit the information relating to an indication and/or likelihood that a network has an MITM attacker thereon to a server such as, for example, a rating server which manages a database storing information relating to an indication and/or likelihood that a network has an MITM attacker thereon or that the network is otherwise unsecure or compromised.

According to various embodiments of the present disclosure, the terminal may sync with a server (e.g., the ratings server) to update information relating to an indication and/or likelihood that a network has an MITM attacker thereon or that the network is otherwise unsecure or compromised. The terminal may update the information relating to an indication and/or likelihood that a network has an MITM attacker for networks within a threshold proximity of the current location of the terminal.

According to various embodiments of the present disclosure, the terminal may provide a user thereof with an indication of the security for networks within a threshold and/or communication range. For example, the terminal may provide the user thereof with information relating to an indication and/or likelihood that a network has an MITM attacker thereon or that the network is otherwise unsecure or compromised. As an example, the terminal may provide the user thereof with information relating to an indication and/or likelihood that a network has an MITM attacker thereon or that the network is otherwise unsecure or compromised alongside a listing of networks within range of the terminal. As an example, if the user attempts to connect the terminal to a network identified as likely being a compromised network, the mobile terminal may prompt the user with a warning and/or a verification that connection to the network is desirable.

According to various embodiments of the present disclosure, the terminal monitors a connection with a network to which the terminal is connected. The terminal may monitor the connection with the network in real-time. According to various embodiments of the present disclosure, the terminal may analyze characteristics of the connection with the network. According to various embodiments of the present disclosure, the terminal may analyze characteristics of the connection with the network in real-time. The terminal may determine a likelihood that a network has an MITM attacker thereon or that the network is otherwise unsecure or compromised. According to various embodiments of the present disclosure, the terminal may transmit information relating to the characteristics of the connection between the terminal and the network to a server.

According to various embodiments of the present disclosure, the server may analyze the characteristics of the connection between the terminal and the network in real-time. The server may determine a likelihood that the network has an MITM attacker thereon or that the network is otherwise unsecure or compromised. For example, the server may assess the risks of terminal connection using statistical analysis methods. For example, the server may assess the risks such as the likelihood that the network has an MITM attacker thereon or that the network is otherwise unsecure or compromised in real-time and provide the terminal information or indications of the risks (e.g., in real-time). According to various embodiments of the present disclosure, the server may transmit an indication as to the likelihood that the network has an MITM attacker thereon or that the network is otherwise unsecure or compromised to the terminal. According to various embodiments of the present disclosure, the server may store information relating to the likelihood that the network has an MITM attacker thereon or whether the network is otherwise unsecure or compromised to the terminal (e.g., in a database). The server may store such information in association with a timestamp which may be used to determine a relevancy of the information at a time of retrieval.

According to various embodiments of the present disclosure, if the server does not store information relating to the domain which the terminal is attempting to access, then the server may repeat a request transferred by the terminal to the domain. As a result, the server may establish a normal behavior of the domain. The server may compare such normal behavior of the domain to the behavior being experienced by the terminal.

According to various embodiments of the present disclosure, a terminal may analyze a connection with a network so as to collect information relating thereto. For example, the terminal may collect information in the form of statistical ratios based on analysis of an http links and https links (e.g., secure links) on a website. As another example, the terminal may collect information in the form of statistical ratios based on form actions, XMLHttpRequests, and/or the like.

According to various embodiments of the present disclosure, the terminal may monitor the behavior of accessing sensitive URLs through http and the possible redirection to https.

According to various embodiments of the present disclosure, the terminal may connect to the server asynchronously on a frequency determined by the rating server. According to various embodiments of the present disclosure, the terminal may connect to the server on a frequency configured by a user (e.g., in accordance with user preferences). According to various embodiments of the present disclosure, the terminal may connect to the server upon connection to a network.

According to various embodiments of the present disclosure, the terminal may communicate network information to the server upon connection to the server. For example, the terminal may communicate to the network an Access Point (AP) identification associated with the network. As another example, the terminal may communicate to the network meta-information associated with the connection between the terminal and the network (e.g., an AP).

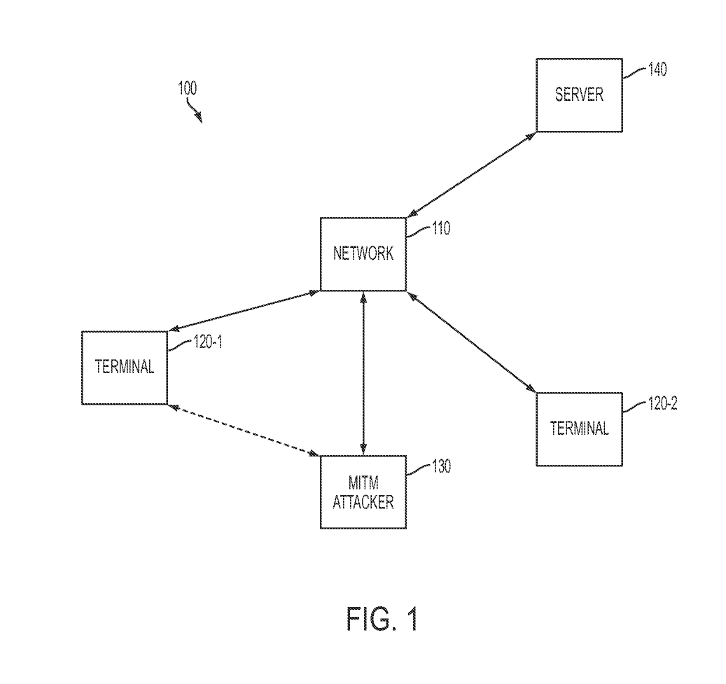

FIG. 1 illustrates a system for identifying an MITM connection according to various embodiments of the present disclosure.

Referring to FIG. 1, the system 100 for identifying an MITM connection includes a network 110 (e.g., an AP) and a terminal 120-1.

According to various embodiments of the present disclosure, the system 100 may also include a server 140 to which the terminal 120-1 may operatively connect to communicate information relating to the network 110 and information relating to the connection between the terminal 120-1 and the network 110.

According to various embodiments of the present disclosure, the terminal 120-1 and/or the server 140 may be respectively configured to detect an MITM attacker 130 connected to the network 110. The MITM attacker 130 may be a terminal that has configured the connection between the terminal 120-1 and the network 110 so as to allow the MITM attacker 130 to monitor all traffic sent from the terminal 120-1 across the network 110 (e.g., to the Internet). The terminal 120-1 and/or the server 140 may detect an MITM attacker 130 by analyzing communication between the terminal 120-1 and the network 110. For example, the terminal 120-1 and/or the server 140 may analyze requested URLs, links within webpages provided to the terminal 120-1, and the like. The terminal 120-1 and/or the server 140 may use the information relating to the communication between the terminal 120-1 and the network 110 to calculate a lightweight statistical measure of the likelihood that the connection between the terminal 120-1 and the network 110 has an MITM attacker 130.

An MITM attacker 130 may establish a connection with the terminal 120-1 so as to perform an Address Resolution protocol (ARP) spoofing (e.g., a technique whereby an MITM attacker 130 sends a fake ARP message across the network 110). As a result, the MITM attacker 130 operatively configures the terminal 120-1 to route all requests intended to be communicated across the network 110 to be sent through the MITM attacker 130. When the first request to a secured server is made over http, the MITM attacker 130 (e.g. using a program such as SSLStrip) forwards the request on behalf of the user (of the terminal 120-1) to the requested website. Typically, a website redirects a user to a secure website (e.g., an https address) at which the user may login. However, the MITM attacker 130 changes the request (or redirection) such that the login to the website is made over an unsecure page (e.g., an http address). Moreover, every further request to the desired website may be routed through the MITM attacker 130. As a result, the MITM attacker 130 is able to convert the content of any web page communicated to the terminal 120-1 so as to rewrite all secure hyperlinks (e.g., https addresses) to insecure hyperlinks (e.g., http addresses).

According to various embodiments of the present disclosure, the terminal 120-1 and/or the server 140 may analyze the ratio of secure hyperlinks to insecure hyperlinks on a website provided to the terminal 120-1 to determine the likelihood that an MITM attacker 130 is compromising the connection between the terminal 120-1 and the network 110. According to various embodiments of the present disclosure, the terminal 120-1 and/or the server 140 may compare the ratio of secure hyperlinks to insecure hyperlinks on the website provided to the terminal 120-1 with historical information (e.g., known or average ratios) of that same website, or with information relating to similar ratios for similarly positioned websites (e.g., websites having the same function, websites within the same industry, and/or the like).

According to various embodiments of the present disclosure, the terminal 120-1 and/or the server 140 may determine whether a presence of an MITM attacker 130 is likely according to whether various statistical thresholds are exceeded or whether suspicious activities occur.

According to various embodiments of the present disclosure, an early indicator or threshold used to determine whether an MITM attacker 130 may be present is when the terminal 120-1 receives an ARP packet indicating a change in the Media Access Control (MAC) address of the default gateway. The terminal 120-1 may receive an ARP packet indicating a change in the MAC address of the default gateway when an MITM attacker 130 actively targets a user on the network 110 which is not controlled by the MITM attacker 130.

According to various embodiments of the present disclosure, an indicator or threshold used to determine an MITM attacker 130 may be present is when the URL of a website corresponds to an insecure website (e.g., an http address) rather than an secure website (e.g., an https address) when historical information relating to the website indicates that the website should be a secure website (e.g., based on prior request history to a known domain, a security rating or other information stored on the sever 140, and/or the like). An attacker such as the MITM attacker 130 may convert links on a requested website without first transmitting an ARP packet indicating a change in the MAC address of the default gateway if the attacker already controls the network 110 (e.g., such that the attacker can monitor traffic across the network 110).

According to various embodiments of the present disclosure, the terminal 120-1 may store URLS for websites and information relating thereto. For example, the terminal 120-1 may store a ratio of a number of secure hyperlinks to a number of insecure hyperlinks (and/or a ratio of a number of insecure hyperlinks to a number of secure hyperlinks) of the resultant page from a URL request. According to various embodiments of the present disclosure, the terminal 120-1 may store such information relating to various websites based on its own historical interne traffic. According to various embodiments of the present disclosure, the terminal 120-1 may communicate such information with the server 140 for aggregation and/or statistical analysis. According to various embodiments of the present disclosure, the terminal 120-1 may receive information for various websites that the terminal 120-1 may use for identifying an MITM attack (e.g., ratio of a number of secure hyperlinks to a number of insecure hyperlinks, and/or the like).

As an example of an instance when an MITM attacker 130 has not compromised a connection between the terminal 120-1 and the network 110, if the user of the terminal 120-1 inputs “www.wellsfargo.com” into a web browser, the web browser converts the initial request to an http web address by default. In response, the web server to which the terminal 120-1 is communicating transmits a 302 redirect to the terminal 120-1 to a mirrored URL over a secure web address (e.g., an https web address). Thereafter, the login page through which the terminal 120-1 logs into the web server is delivered over a secure web page (e.g., an https web address). Moreover, all subsequent requests between the terminal 120-1 and web server are made over a secure connection (e.g., over an https web page).

In contrast, if an MITM attacker 130 has compromised the connection between the terminal 120-1 and the network 110, then when the user inputs “www.wellsfargo.com” without either an http or an https prefix, the resultant URL is an insecure web address (e.g., an http web address) because the MITM attacker 130 has rewritten the response transmitted from the web server to the terminal 120-1 to include an http web address rather than an https web address (e.g., the MITM attacker 130 converts the secure https web address in the response from the web server to an insecure http web address).

In view of the above, the failure of the web page with which the terminal 120-1 is communicating to redirect to a secure web site may be an indication that the connection between the terminal 120-1 and the network 110 is compromised by an MITM attacker 130. However, some web sites with non-sensitive information will not redirect to a secure connection (e.g., SSL connection) as part of the standard behavior of the web site.

According to various embodiments of the present disclosure, the terminal 120-1 and/or the server 140 may store a database including information that indicates whether a domain is known to not redirect to a secured connection (e.g., redirect to an https web address). For example, the terminal 120-1 may perform a local lookup to the database to see if the resultant URL being non-https falls within normal behavior for the domain. If the local database queried by the terminal 120-1 does not store information about the domain therein, then the terminal 120-1 may transmit a request to the server 140 so as to query aggregated normalized behavior of the domain (and also to further inform the server 140 of the behavior experienced by the terminal 120-1 so that the server 140 can aggregate behavior of the database and update the information stored thereon). In response to the query from the terminal 120-1 about a domain, the server 140 may communicate normalized behavior of the domain. For example, the server 140 may communicate to the terminal 120-1 information including a ratio of the number insecure hyperlinks to the number of secure hyperlinks for the domain (e.g., ratio of http to https links, or the like), form actions, hrefs, and XMLHttpRequests, and the like that are expected for normalized behavior of the domain or webpage.

According to various embodiments of the present disclosure, the terminal 120-1 may analyze the webpage in comparison to the information relating to the expected normalized behavior for that webpage which was received from the server 140. According to various embodiments of the present disclosure, if the terminal 120-1 determines that the behavior of the domain or webpage is consistent with the expected normalized behavior, then the terminal 120-1 may continue browsing normally. In contrast, if the terminal 120-1 determines that the behavior or characteristics of the domain or webpage differs significantly from the expected normalized behavior for the domain received by the server 140, then the terminal 120-1 may determine that an MITM attack has been identified and thus may determine that an MITM attacker 130 exists within the system 100 or on the network 110. Further, when the terminal 120-1 determines that an MITM attack has been identified, the terminal 120-1 informs the user of the terminal 120-1 of such a determination.

According to various embodiments of the present disclosure, the terminal 120-1 may blacklist the network 110 after determining that an MITM attack is identified. According to various embodiments of the present disclosure, the terminal 120-1 may inform the server 140 of the MITM attack so that the server 140 may update information relating to ratings of networks or other information relating to security of the network 110.

According to various embodiments of the present disclosure, receipt by the terminal 120-1 of an ARP packet indicating a change in the MAC address of the default gateway and a URL of the website corresponding to an insecure website for a known domain (e.g., a domain that is known to switch from an insecure website (e.g., an http address) to a secure website (e.g., an https address)) indicates a strong likelihood that the presence of an MITM attacker 130 and thus an MITM attack is confirmed.

According to various embodiments of the present disclosure, the system 100 may also include another terminal 120-2 that is operatively connected to the network. The terminal 120-2 may be configured to communicate directly with the terminal 120-1. For example, terminal 120-1 and terminal 130 may communicate with each other without using the network 110 to transmit such communications. As an example, the terminal 120-1 and terminal 120-2 may communicate using Bluetooth technology, Near Field Communication (NFC) technology, and/or the like.

According to various embodiments of the present disclosure, the terminal 120-1 may communicate to the terminal 120-2 information relating to the likelihood that the network has an MITM attacker 130 thereon or whether the network 110 is otherwise unsecure or compromised. For example, the communication from the terminal 120-1 to the terminal 120-2 may serve as a warning to the terminal 120-2 of the likelihood of a presence of an MITM attacker 130 on the network 110. According to various embodiments of the present disclosure, upon receipt of information relating to the likelihood that the network 110 has an MITM attacker 130 thereon or whether the network 110 is otherwise unsecure or compromised, the terminal 120-1 and the terminal 120-2 may respectively provide a user thereof with a prompt querying whether the user thereof wants to disconnect from the network 110.

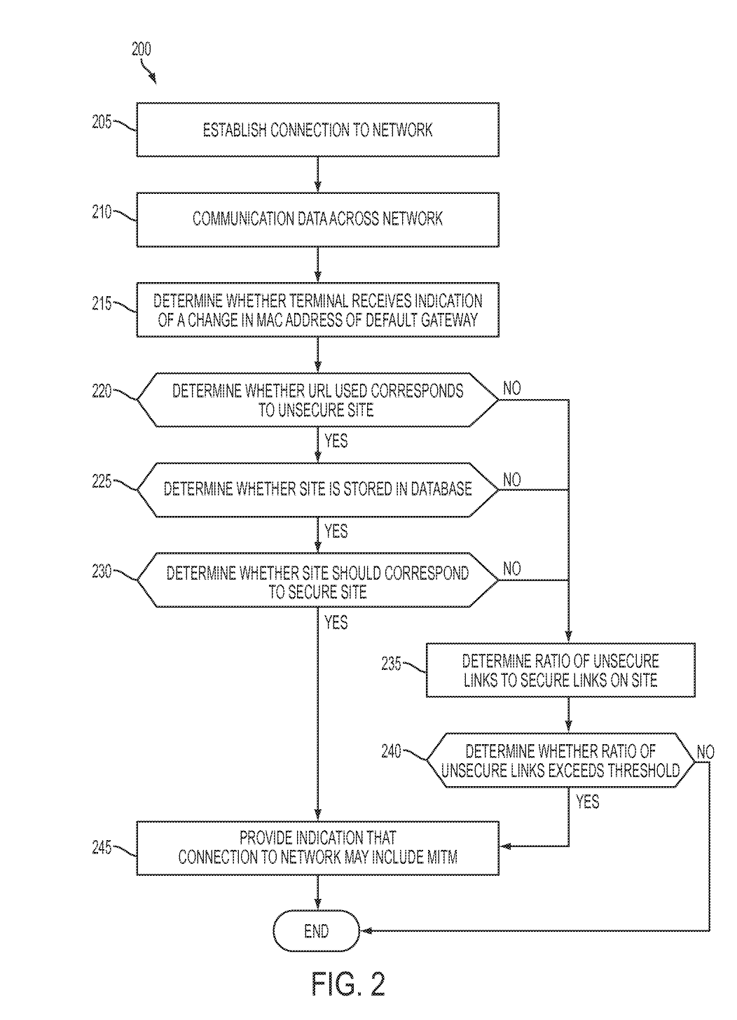

FIG. 2 is a flowchart illustrating a method of identifying an MITM connection according to various embodiment of the present disclosure.

Referring to FIG. 2, at operation 205, a terminal may establish a connection to a network. For example, the terminal may connect to an AP (e.g., WiFi AP).

At operation 210, the terminal communicates data across the network. For example, the terminal may access various domains or websites. The terminal may communicate with domains for which security of information transfer is preferred. For example, the terminal may communicate sensitive authentication information, financially sensitive information, and/or personal identifiable information with the domain.

At operation 230, the terminal may determine whether the URL with which the terminal communicates corresponds to an insecure site. For example, the terminal may determine whether the URL corresponds to an http website.

If the terminal determines that the URL with which the terminal communicates corresponds to an insecure site at operation 220, then the terminal may proceed to operation 225 at which the terminal determines whether the domain or site has information stored thereabout in a database. For example, the terminal may determine whether a local database (e.g., stored at the terminal) includes information about the domain. As another example, the terminal may transmit a query to a server (e.g., a ratings server) to inquire as to whether a database stored on the server includes information about the domain. According to various embodiments of the present disclosure, the terminal may first determine whether the local database includes information about the domain, and if the local database does not store information about the terminal, then the terminal may thereafter query the server for information relating to the domain.

If the terminal determines that the domain or site has information stored thereabout in a database (e.g., either stored locally, or stored on a server) at operation 225, then the terminal may proceed to operation 230 at which the terminal determines whether the domain or site should correspond to a secure site. For example, the terminal references the information about the domain that is stored in the database to determine whether the domain or site should correspond to a secure site.

If the terminal determines that the domain or site should correspond to a secure site at operation 230, then the terminal may proceed to operation 245 at which the terminal provides an indication that connection to the network may include an MITM. For example, the terminal may provide an indication to the user of the terminal that the network may include an MITM. The terminal may further prompt the user for an indication as to whether to disconnect the terminal from the network. The terminal may further prompt the user for an indication as to whether to blacklist the network. The terminal may further prompt the user for an indication as to whether to inform other terminals connected to the network and/or the server of the MITM on the network. According to various embodiments of the present disclosure, the terminal may automatically transmit an indication of the MITM to the server and/or other terminals connected to the network.

In contrast, if the terminal determines that the URL with which the terminal communicates does not correspond to an insecure site at operation 220, then the terminal may proceed to operation 235 at which the terminal determines a ratio of a number of insecure hyperlinks to a number of a number of secure hyperlinks on the site. According to various embodiments of the present disclosure, the terminal may analyze the site to determine the ratio of a number of insecure hyperlinks to a number of a number of secure hyperlinks. According to various embodiments of the present disclosure, the terminal may transmit information about the site to a server which may determine the ratio of a number of insecure hyperlinks to a number of a number of secure hyperlinks in real time and provide an indication of the ratio to the terminal.

According to various embodiments of the present disclosure, if the terminal determines that the URL with which the terminal communicates does not correspond to an insecure site (e.g., if the URL corresponds to a secure site) at operation 220, then the terminal may end the method of identifying an MITM connection.

Similarly, if the terminal determines that the domain or site does not have information stored thereabout in a database (e.g., either stored locally, or stored on a server) at operation 225, then the terminal may proceed to operation 235 at which the terminal may determine the ratio of a number of insecure hyperlinks to a number of a number of secure hyperlinks on the site, as described above.

According to various embodiments of the present disclosure, if the terminal determines that the domain or site does not have information stored thereabout in a database (e.g., either stored locally, or stored on a server) at operation 225, then a server may repeat the request made from the terminal to the domain. For example, the server may repeat the request made from the terminal to the domain so as to establish a basis for the normal behavior of the domain. For example, the server may calculate the ratio of a number of insecure hyperlinks to a number of a number of secure hyperlinks on the site, or the like. The server may determine various characteristics of the domain corresponding to a normal behavior of the domain.

Moreover, if the terminal determines that the domain or site should not necessarily correspond to a secure site at operation 230, then the terminal may proceed to operation 235 at which the terminal may determine the ratio of a number of insecure hyperlinks to a number of a number of secure hyperlinks on the site, as described above.

Upon determining the ratio of the number of insecure hyperlinks to the number of a number of secure hyperlinks on the site at operation 235, the terminal proceeds to operation 240 at which the terminal determines whether the ratio of the number of insecure hyperlinks to the number of a number of secure hyperlinks exceeds a threshold. For example, the terminal may compare the ratio of the number of insecure hyperlinks to the number of a number of secure hyperlinks on the site to a threshold stored in a database about the site or similarly situated sites (e.g., sites having the same functionality, sites provided by companies in the same industry, and/or the like). The terminal may retrieve the threshold from a locally stored database or a database stored on a server (e.g., a ratings server).

If the terminal determines that the ratio of the number of insecure hyperlinks to the number of a number of secure hyperlinks exceeds the threshold at operation 240, then the terminal may proceed to operation 245 at which the terminal provides an indication that connection to the network may include an MITM, as described above.

In contrast, if the terminal determines that that the ratio of the number of insecure hyperlinks to the number of a number of secure hyperlinks does not exceed (e.g., is less than or equal to) the threshold at operation 240, then the terminal may end the process for identifying the MITM connection.

According to various embodiments of the present disclosure, the terminal may perform operations 205 through operation 245 as the terminal browses a new domain or at defined intervals (e.g., which may be configurable by a user).

According to various embodiments of the present disclosure, the terminal may perform operations 205 through operation 245 in a different order. According to various embodiments of the present disclosure, two or more of operations 205 through 245 may be combined to be performed as a single operation. According to various embodiments of the present disclosure, additional operations may be performed before or after any of operations 205 through 245.

According to various embodiments of the present disclosure, even if the terminal determines that the domain or site should correspond to a secure site at operation 230, the terminal may proceed to operation 235 and perform operations 235 and 240 for a more robust method for identifying an MITM connection.

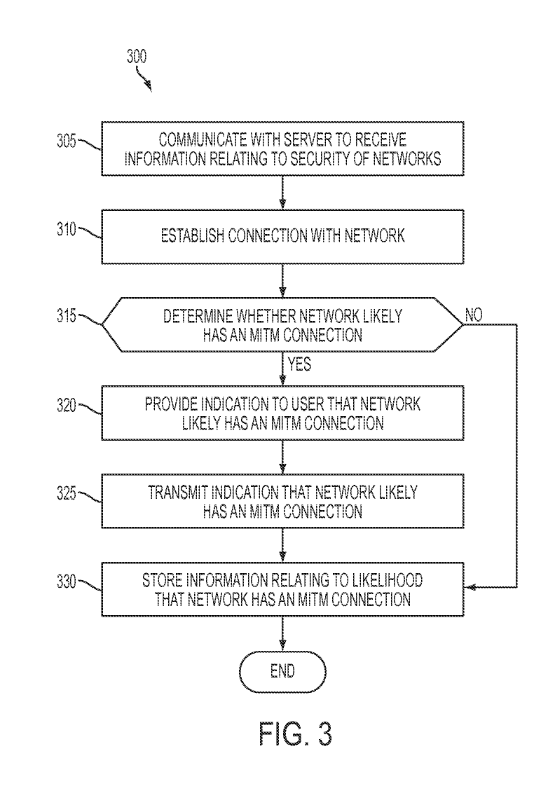

FIG. 3 is a flowchart illustrating a method of identifying an MITM connection according to various embodiment of the present disclosure.

Referring to FIG. 3, at operation 305, the terminal communicates with a server to receive information relating to security of networks. For example, the terminal may sync with the server (e.g., a ratings server) to retrieve information relating to the security of a predefined set of networks. According to various embodiments of the present disclosure, the predefined set of networks may be configurable by a user. According to various embodiments of the present disclosure, the predefined set of networks may correspond to a set of networks within a defined geographical area, a set of networks provided by a same provider, a set of networks within a defined proximity of the terminal, and/or the like. According to various embodiments of the present disclosure, the received information may include an indication as to a likelihood of each of the networks being compromised by an MITM attacker or otherwise insecure. According to various embodiments of the present disclosure, the received information may include ratings (e.g., of security) of the set of networks for which the information relates. According to various embodiments of the present disclosure, the received information may provide an indication of a last reported MITM attacker on a network in the set of networks for which the information relates.

According to various embodiments of the present disclosure, the terminal may further receive information relating to an expected behavior of a set of domains (e.g., which may be configurable by the user). For example, the received information may include an expected ratio of the number of insecure links to the number of secure links on sites from that domain. As another example, the received information may include an expected behavior as to whether a domain uses a secure or an insecure site.

At operation 310, the terminal establishes a connection with a network.

At operation 315, the terminal determines whether the network likely has an MITM connection (e.g., whether the network likely has an MITM attacker thereon). According to various embodiments of the present disclosure, the terminal may analyze the behavior of the network and/or the characteristics of the websites or domains which the terminal is browsing or accessing. According to various embodiments of the present disclosure, the terminal may report the behavior of the network and/or the characteristics of the websites or domains which the terminal is browsing or accessing to a server for real-time analysis and/or feedback on the likelihood that the network has an MITM connection. According to various embodiments of the present disclosure, the terminal may compare the behavior of the network and/or the characteristics of the websites or domains which the terminal is browsing or accessing to an expected behavior based on historical information of the network and/or the domain, information relating to similarly situated networks and/or domains.

If the terminal determines that the network likely has an MITM connection at operation 315, then the terminal may proceed to operation 320 at which the terminal provides an indication to the user of the terminal that the network likely has an MITM connection. According to various embodiments of the present disclosure, the terminal may prompt the user for an indication as to whether the user wishes to disconnect and/or blacklist the network. Thereafter, the terminal may proceed to operation 325.

At operation 325, the terminal may transmit an indication that the network likely has an MITM connection. According to various embodiments of the present disclosure, the terminal may transmit the indication to the server so that the server may aggregate network characteristics and behavior and provide ratings of network security to terminals. According to various embodiments of the present disclosure, the terminal may transmit the indication to at least one other terminal connected to the network. Thereafter, the terminal may proceed to operation 330.

At operation 330, information relating to the likelihood that the network has an MITM connection may be stored. According to various embodiments of the present disclosure, the terminal and/or the server may store the information relating to the likelihood that the network has an MITM connection. According to various embodiments of the present disclosure, the terminal and/or the server may store an indication that the network is blacklisted if the network is determined to likely have an MITM connection.

In contrast, if the terminal determines that the network does not likely have an MITM connection at operation 315, then the terminal may proceed to operation 330 at which the information relating to the likelihood that the network has an MITM connection may be stored.

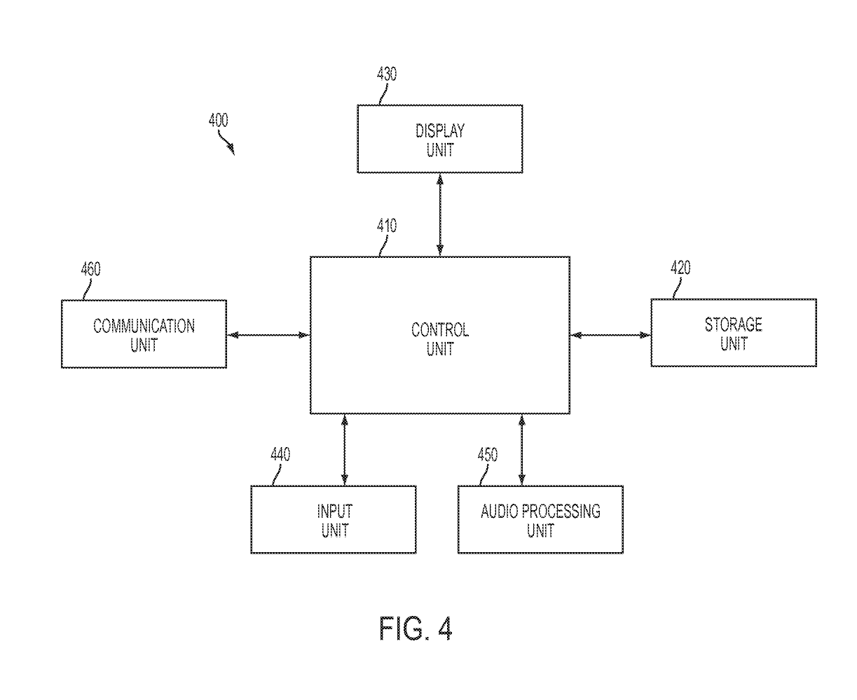

FIG. 4 is a block diagram of a terminal according to various embodiments of the present disclosure.

Referring to FIG. 4, the terminal 400 includes a control unit 410, a storage unit 420, a display unit 430, an input unit 440, and a communication unit 460. According to various embodiments of the present disclosure, the terminal 400 may also include an audio processing unit 450.

According to various embodiments of the present disclosure, the terminal 400 comprises at least one control unit 410. The at least one control unit 410 may be configured to operatively control the terminal 400. For example, the at least one control unit 410 may control operation of the various components or units included in the terminal 400. The at least one control unit 410 may transmit a signal to the various components included in the terminal 400 and control a signal flow between internal blocks of the terminal 400. In particular, according to various embodiments of the present disclosure, the at least one control unit 410 may perform an action (e.g., a command, function, or the like) according to an input. For example, the at least one control unit 410 may connect to a network. The at least one control unit 410 may determine whether the network (e.g., or the connection between the terminal 400 and the network) has an MITM connection. The at least one control unit 410 may determine a likelihood that the network (e.g., or the connection between the terminal 400 and the network) has an MITM connection. The at least one control unit 410 may operatively browse domains and/or websites. The at least one control unit 410 may analyze characteristics and behaviors of the network and/or the domains or websites being browsed by the terminal 400. The at least one control unit 410 may compare the characteristics and behaviors of the network and/or the domains or websites to expected (e.g., normalized) behavior of the network and/or the domains or websites being browsed by the terminal 400. According to various embodiments of the present disclosure, the expected (e.g., normalized) behavior of the network and/or the domains or websites being browsed by the terminal 400 may correspond to expected behaviors based on historical experience and/or information for such specific network and/or domains or websites. According to various embodiments of the present disclosure, the expected (e.g., normalized) behavior of the network and/or the domains or websites being browsed by the terminal 400 may correspond to expected behaviors based on information and historical behaviors of similarly situated network and/or domains or websites (e.g., networks provided by the same provider, domains and/or websites for offering similar services or functionality, domains and/or websites within the same industry). The at least one control unit 410 may operatively communicate with a server (e.g., a ratings server) to transmit and receive information relating to a network and/or a domain or website being browsed. For example, the at least one control unit 410 may operatively communicate with a server (e.g., a ratings server) to transmit and receive information relating to the observed or expected behavior of the network and/or the domain or website being browsed.

The storage unit 420 can store user data, and the like, as well a program which performs operating functions according to various embodiments of the present disclosure. The storage unit 420 may include a non-transitory computer-readable storage medium. As an example, the storage unit 420 may store a program for controlling general operation of a terminal 400, an Operating System (OS) which boots the terminal 400, and application program for performing other optional functions such as a camera function, a sound replay function, an image or video replay function, a signal strength measurement function, a route generation function, image processing, and the like. Further, the storage unit 420 may store user data generated according to a user of the terminal 400, such as, for example, a text message, a game file, a music file, a movie file, and the like. In particular, according to various embodiments of the present disclosure, the storage unit 420 may store an application or a plurality of applications that individually or in combination determine a likelihood that a network has an MITM connection and/or that a connection between the terminal 400 and the network has an MITM attacker therebetween. According to various embodiments of the present disclosure, the storage unit 420 may store an application or a plurality of applications that individually or in combination inform at least one of a user, another terminal connected to the network, and a server (e.g., a ratings server) of the likelihood that the network has an MITM connection. According to various embodiments of the present disclosure, the storage unit 420 may store an application or a plurality of applications that individually or in combination enable communication between the terminal 400 and a server to exchange information relating to characteristics and/or behaviors of the network and/or domains or websites being browsed.

The display unit 430 displays information inputted by user or information to be provided to user as well as various menus of the terminal 400. For example, the display unit 430 may provide various screens according to a user of the terminal 400, such as an idle screen, a message writing screen, a calling screen, a route planning screen, and the like. In particular, according to various embodiments of the present disclosure, the display unit 430 can display a menu. The menu may include a list of networks to which the terminal 400 may connect. For example, the menu may include an indication as to whether a network is blacklisted, whether a network is likely to have an MITM connection, a likelihood that the network has an MITM connection, and/or the like. According to various embodiments of the present disclosure, the menu may include settings for communicating an indication that a network or network connection has an MITM connection. For example, the menu may include settings for communicating the indication or warnings that an MITM connection may be present to the user, to at least one other terminal connected to the network, and/or a server (e.g., a ratings server). The display unit 430 may display alerts or prompts relating to the presence of an MITM connection and/or a likelihood of an MITM connection. According to various embodiments of the present disclosure, the display unit 430 may display an interface which the user may manipulate or otherwise enter inputs via a touch screen to enter selection of the function relating to the signal strength of the terminal 400. The display unit 430 can be formed as a Liquid Crystal Display (LCD), an Organic Light Emitting Diode (OLED), an Active Matrix Organic Light Emitting Diode (AMOLED), and the like. However, various embodiments of the present disclosure are not limited to these examples. Further, the display unit 430 can perform the function of the input unit 440 if the display unit 430 is formed as a touch screen.

The input unit 440 may include input keys and function keys for receiving user input. For example, the input unit 440 may include input keys and function keys for receiving an input of numbers or various sets of letter information, setting various functions, and controlling functions of the terminal 400. For example, the input unit 440 may include a calling key for requesting a voice call, a video call request key for requesting a video call, a termination key for requesting termination of a voice call or a video call, a volume key for adjusting output volume of an audio signal, a direction key, and the like. In particular, according to various embodiments of the present disclosure, the input unit 440 may transmit to the at least one control unit 410 signals related to selection or setting of functions relating to the network connections, alerting at least one other terminal and/or server about a potential MITM connection, and the like. Such an input unit 440 may be formed by one or a combination of input means such as a touch pad, a touchscreen, a button-type key pad, a joystick, a wheel key, and the like.

The communication unit 460 may be configured for communicating with other devices and/or networks. According to various embodiments of the present disclosure, the communication unit 460 may be configured to communicate using various communication protocols and various communication transceivers. For example, the communication unit 460 may be configured to communicate via Bluetooth technology, NFC technology, WiFi technology, 2G technology, 3G technology, LTE technology, or another wireless technology, and/or the like.

The audio processing unit 450 may be formed as an acoustic component. The audio processing unit 450 transmits and receives audio signals, and encodes and decodes the audio signals. For example, the audio processing unit 450 may include a CODEC and an audio amplifier. The audio processing unit 450 is connected to a Microphone (MIC) and a Speaker (SPK). The audio processing unit 450 converts analog voice signals inputted from the Microphone (MIC) into digital voice signals, generates corresponding data for the digital voice signals, and transmits the data to the at least one control unit 410. Further, the audio processing unit 450 converts digital voice signals inputted from the at least one control unit 410 into analog voice signals, and outputs the analog voice signals through the Speaker (SPK). Further, the audio processing unit 450 may output various audio signals generated in the terminal 400 through the Speaker (SPK). For example, the audio processing unit 450 can output audio signals according to an audio file (e.g. MP3 file) replay, a moving picture file replay, and the like through the speaker. In particular, according to various embodiments of the present disclosure, the audio processing unit 450 may provide a user with an alert or warning that the network likely has an MITM connection.

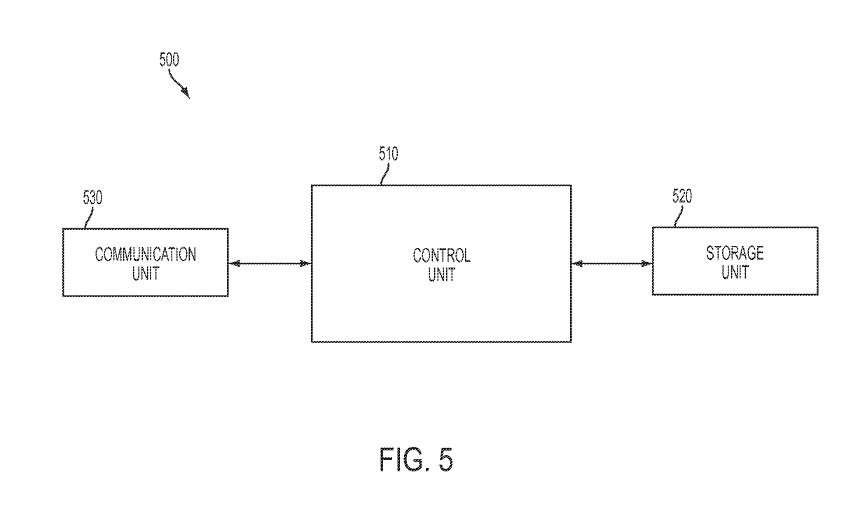

FIG. 5 is a block diagram of an Access Point (AP) according to various embodiments of the present disclosure.

Referring to FIG. 5, the AP 500 includes a control unit 510, a storage unit 520, and a communication unit 530.

According to various embodiments of the present disclosure, the AP 500 comprises at least one control unit 510. The at least one control unit 510 may be configured to operatively control the AP 500. For example, the at least one control unit 510 may control operation of the various components or units included in the AP 500. The at least one control unit 510 may transmit a signal to the various components included in the AP 500 and control a signal flow between internal blocks of the AP 500. In particular, according to various embodiments of the present disclosure, the at least one control unit 510 may perform an action (e.g., a command, function, or the like) according to an input. For example, the at least one control unit 510 may manage communication across a network. The at least one control unit 510 may determine whether the network (e.g., or the connection between a terminal and the AP 500) has an MITM connection. The at least one control unit 510 may determine a likelihood that the network (e.g., or the connection between a terminal and the AP 500) has an MITM connection. The at least one control unit 510 may analyze characteristics and behaviors of the network and/or the domains or websites being browsed by a terminal. The at least one control unit 510 may compare the characteristics and behaviors of the network and/or the domains or websites to expected (e.g., normalized) behavior of the network and/or the domains or websites being browsed by the terminal According to various embodiments of the present disclosure, the expected (e.g., normalized) behavior of the network and/or the domains or websites being browsed by the terminal may correspond to expected behaviors based on historical experience and/or information for such specific network and/or domains or websites. According to various embodiments of the present disclosure, the expected (e.g., normalized) behavior of the network and/or the domains or websites being browsed by the terminal may correspond to expected behaviors based on information and historical behaviors of similarly situated networks and/or domains or websites (e.g., networks provided by the same provider, domains and/or websites for offering similar services or functionality, domains and/or websites within the same industry). The at least one control unit 510 may operatively communicate with a server (e.g., a ratings server) to transmit and receive information relating to the AP 500 and/or a domain or website being browsed. For example, the at least one control unit 510 may operatively communicate with a server (e.g., a ratings server) to transmit and receive information relating to the observed or expected behavior of the domain or website being browsed.

The storage unit 520 can store user data, and the like, as well a program which performs operating functions according to various embodiments of the present disclosure. The storage unit 520 may include a non-transitory computer-readable storage medium. As an example, the storage unit 520 may store a program for controlling general operation of the AP 500, an Operating System (OS) which boots the AP 500, and application program for performing other optional functions, and the like. In particular, according to various embodiments of the present disclosure, the storage unit 520 may store an application for managing communication across a network. For example, the storage unit 520 may store an application to enable the AP 500 to coordinate communication with at least one terminal and another terminal and/or another network. According to various embodiments of the present disclosure, the storage unit 520 may store historical information of the likelihood that the AP 500 has an MITM connection.

The communication unit 530 may be configured for communicating with other devices and/or networks. According to various embodiments of the present disclosure, the communication unit 530 may be configured to communicate using various communication protocols and various communication transceivers. For example, the communication unit 530 may be configured to communicate via Bluetooth technology, NFC technology, WiFi technology, 2G technology, 3G technology, LTE technology, or another wireless technology, and/or the like.

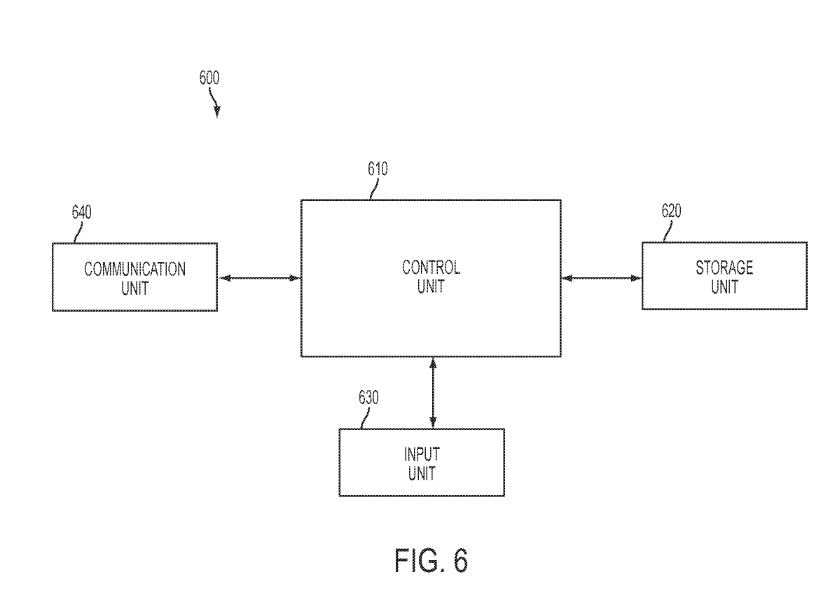

FIG. 6 is a block diagram of a server according to various embodiments of the present disclosure.

Referring to FIG. 6, the server 600 includes a control unit 610, a storage unit 620, and a communication unit 640. The server 600 may also include an input unit 630.

According to various embodiments of the present disclosure, the server 600 comprises at least one control unit 610. The at least one control unit 610 may be configured to operatively control the server 600. For example, the at least one control unit 610 may control operation of the various components or units included in the server 600. The at least one control unit 610 may transmit a signal to the various components included in the server 600 and control a signal flow between internal blocks of the server 600. In particular, according to various embodiments of the present disclosure, the at least one control unit 610 may perform an action (e.g., a command, function, or the like) according to an input. For example, the at least one control unit 610 may communicate with a terminal (e.g., across a network). The at least one control unit 610 may determine whether the network (e.g., or the connection between a terminal and the network) has an MITM connection. The at least one control unit 610 may determine a likelihood that the network (e.g., or the connection between the terminal and the network) has an MITM connection. The at least one control unit 610 may analyze characteristics and behaviors of the network and/or the domains or websites being browsed by the terminal. The at least one control unit 610 may compare the characteristics and behaviors of the network and/or the domains or websites to expected (e.g., normalized) behavior of the network and/or the domains or websites being browsed by the terminal. According to various embodiments of the present disclosure, the expected (e.g., normalized) behavior of the network and/or the domains or websites being browsed by the terminal may correspond to expected behaviors based on historical experience and/or information for such specific network and/or domains or websites. According to various embodiments of the present disclosure, the expected (e.g., normalized) behavior of the network and/or the domains or websites being browsed by the terminal may correspond to expected behaviors based on information and historical behaviors of similarly situated network and/or domains or websites (e.g., networks provided by the same provider, domains and/or websites for offering similar services or functionality, domains and/or websites within the same industry). The at least one control unit 610 may operatively communicate with a terminal to transmit and receive information relating to a network and/or a domain or website being browsed. For example, the at least one control unit 610 may operatively communicate with a terminal to transmit and receive information relating to the observed or expected behavior of the network and/or the domain or website being browsed.

The storage unit 620 can store user data, and the like, as well a program which performs operating functions according to various embodiments of the present disclosure. The storage unit 620 may include a non-transitory computer-readable storage medium. As an example, the storage unit 620 may store a program for controlling general operation of a server 600, an Operating System (OS) which boots the server 600, and application program for performing other optional functions, and the like. Further, the storage unit 620 may store user data generated according to functioning of the server 600, and the like. In particular, according to various embodiments of the present disclosure, the storage unit 620 may store an application or a plurality of applications that individually or in combination determine a likelihood that a network has an MITM connection and/or that a connection between a terminal and the network has an MITM attacker therebetween. According to various embodiments of the present disclosure, the storage unit 620 may store an application or a plurality of applications that individually or in combination inform at least one of a terminal, and another terminal connected to the network of the likelihood that the network has an MITM connection. According to various embodiments of the present disclosure, the storage unit 620 may store an application or a plurality of applications that individually or in combination enable communication between a terminal and the server 600 to exchange information relating to characteristics and/or behaviors of the network and/or domains or websites being browsed. The storage unit 620 may store aggregated data characteristics and/or behaviors of the network and/or domains or websites being browsed.

The communication unit 630 may be configured for communicating with other devices and/or networks. According to various embodiments of the present disclosure, the communication unit 630 may be configured to communicate using various communication protocols and various communication transceivers. For example, the communication unit 630 may be configured to communicate via Bluetooth technology, NFC technology, WiFi technology, 2G technology, 3G technology, LTE technology, or another wireless technology, and/or the like.

The input unit 630 may include input keys and function keys for receiving user input. For example, the input unit 630 may include input keys and function keys for receiving an input of numbers or various sets of letter information, setting various functions, and controlling functions of the server 600. According to various embodiments of the present disclosure, the input unit 630 may transmit to the at least one control unit 610 signals related to configuration of a database relating to the network connections, configuring alerts to alert at least one other terminal and/or server about a potential MITM connection, and the like. Such an input unit 630 may be formed by one or a combination of input means such as a touch pad, a touchscreen, a button-type key pad, a joystick, a wheel key, keyboard, mouse, and the like

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for identifying a Man-In-The-Middle (MITM) connection, the method comprising:
browsing a website using a terminal operatively connected to a network;
determining a security level of the website according to characteristics of the website;
determining whether the security level of the website is consistent with the stored information relating to the security of the website; and
providing an indication that the network has an elevated likelihood of having an MITM if the security level of the website is inconsistent with the stored information relating to the security of the website.

2. The method of claim 1, wherein the determining of the security level of the website comprises:
determining the security level of the website according to whether the website is provided as a secure website or an insecure website.

3. The method of claim 1, wherein the determining of whether the security level of the website is consistent with the stored information comprises:
determining whether a database stores information indicating whether the website is provided as a secure website or an insecure website in the absence of an MITM connection.

4. The method of claim 3, wherein, if the website is not known to be provided as a secure website in the absence of an MITM connection, the determining of whether the security level of the website is consistent with the stored information relating to the security of the website comprises:
comparing characteristics relating to a number of at least one of hyperlinks to secure pages and hyperlinks to insecure pages to a threshold.

5. The method of claim 4, wherein the threshold is an expected value based on aggregated information.

6. The method of claim 5, wherein the aggregated information includes information relating to at least one of historical information for the website, information for websites having similar functionality, and information for websites in a similar industry.

7. The method of claim 3, wherein the determining of whether the security level of the website is consistent with the stored information further comprises:
repeating, by a server, a request made by the terminal to the website if the database is determined not to store information indicating whether the website is provided as a secure website or an insecure website in the absence of an MITM connection.

8. The method of claim 7, wherein the determining of whether the security level of the website is consistent with the stored information further comprises:
determining a normal behavior of the website based on a response to the repeated request made by the server.

9. The method of claim 1, wherein the providing of the indication that the network has an elevated likelihood of having the MITM connection comprises:
alerting a user of the elevated likelihood.

10. The method of claim 9, wherein the alerting the user of the elected likelihood comprises:
prompting the user for an indication as to whether to disconnect from the mobile terminal.

11. The method of claim 1, wherein the providing of the indication that the network has an elevated likelihood of having the MITM connection comprises:
transmitting the indication to another terminal connected to the network.

12. The method of claim 1, wherein the providing of the indication that the network has an elevated likelihood of having the MITM connection comprises:
transmitting the indication to a ratings server.

13. A non-transitory computer-readable storage medium storing instructions that, when executed, cause at least one processor to perform the method of claim 1.

14. An apparatus for identifying a Man-In-The-Middle (MITM) connection, the apparatus comprising:
a communication unit configured to communicate with a network; and
a control unit configured to browse a website, to determine a security level of the website according to characteristics of the website, to determine whether the security level of the website is consistent with the stored information relating to the security of the website, and to provide an indication that the network has an elevated likelihood of having an MITM if the security level of the website is inconsistent with the stored information relating to the security of the website.

15. The apparatus of claim 14, wherein the control unit is further configured to determine the security level of the website according to whether the website is provided as a secure website or an insecure website.

16. The apparatus of claim 14, wherein the control unit is further configured to determine whether a database stores information indicating whether the website is provided as a secure website or an insecure website in the absence of an MITM connection.

17. The apparatus of claim 16, wherein the control unit is further configured to comparing characteristics relating to a number of at least one of hyperlinks to secure pages and hyperlinks to insecure pages to a threshold, if the website is not known to be provided as a secure website in the absence of an MITM connection.

18. The apparatus of claim 17, wherein the threshold is an expected value based on aggregated information.

19. The apparatus of claim 18, wherein the aggregated information includes information relating to at least one of historical information for the website, information for websites having similar functionality, and information for websites in a similar industry.

20. The apparatus of claim 16, wherein the control unit is further configured to receive a normal behavior of the website based on a server repeating a request made by the apparatus to the website if the database is determined not to store information indicating whether the website is provided as a secure website or an insecure website in the absence of an MITM connection.

21. The apparatus of claim 20, wherein the control unit is further configured to determine a normal behavior of the website based on a response to the repeated request made by the server.

22. The apparatus of claim 14, wherein the control unit is further configured to provide an indication that the network has an elevated likelihood of having an MITM connection by alerting a user of the elevated likelihood.

23. The apparatus of claim 22, wherein the control unit is further configured to prompt the user for an indication as to whether to disconnect from the mobile terminal when the control unit determines that there is an elevated likelihood that the network has an MITM connection.

24. The apparatus of claim 14, wherein the control unit is further configured to transmit the indication that the network has an elevated likelihood of having the MITM connection to another terminal connected to the network.

25. The apparatus of claim 14, wherein the control unit is further configured to transmit the indication that the network has an elevated likelihood of having the MITM connection to a ratings server.

26. A method for identifying a Man-In-The-Middle (MITM) connection, the method comprising:
browsing a website using a terminal operatively connected to a network;
determining a security level of the website according to whether the website is provided as a secure website or an insecure website;
determining whether a database stores information relating to a security of the website;
if the database is determined to store information relating to the security of the website, determining whether the security level of the website is consistent with the stored information relating to the security of the website; and
providing an indication that the network has an elevated likelihood of having an MITM if the security level of the website is inconsistent with the stored information relating to the security of the website.

27. A system for identifying a Man-In-The-Middle (MITM) connection, the method comprising:
an Access Point (AP) configured to provide access to a network; and
a terminal configured to communicate with the network, to browse a website, to determine a security level of the website according to characteristics of the website, to determine whether the security level of the website is consistent with the stored information relating to the security of the website, and to provide an indication that the network has an elevated likelihood of having an MITM if the security level of the website if inconsistent with the stored information relating to the security of the website.

28. The system of claim 27, further comprising:
a ratings server configured to store information relating to at least one of a security level of the AP, and expected characteristics of the website.

29. The system of claim 29, wherein the ratings server is configured to repeat a request made by a terminal to a website if the ratings server does not store information relating to a normal behavior of the website.
